(19) United States
(12) Patent Application Publication
(10) Pub. No.: US 2003/0031822 A1
(43) Pub. Date: Feb. 13, 2003

(54) Method of finishing a belt seam, an intermediate transfer belt finished in accordance with the same method, and a printing machine with an intermediate transfer belt finished in accordance with the same method

(75) Inventors: Paul F. Mastro, Pittsford, NY (US); Daniel L. Coughlin JR., Elba, NY (US); Thomas L. DiGravio, Ontario, NY (US)

Correspondence Address: Xerox Corporation, Patent Documentation Center, Xerox Square 20th Floor, 100 Clinton Ave. S., Rochester, NY, 14644, US

(73) Assignee: Xerox Corporation

(21) Appl. No.: 10/268,145

(22) Filed: Oct. 9, 2002

Related U.S. Application Data
(62) Division of application No. 09/723,150, filed on Nov. 27, 2000.

(51) Int. Cl. B32B 3/00

(52) U.S. Cl. 428/58

(57) ABSTRACT

An intermediate transfer belt includes a seam that is finished using a finishing machine. The intermediate transfer belt comprises a belt outer surface and a belt inner surface. The seam comprises a seam outer surface of a seam width with adhesive material disposed thereon. The finishing process includes a finishing media with a finishing surface and a backer bar. The backer bar comprises a backer bar radius and a backer bar surface with a backer surface curvature based on the backer bar radius. The backer bar surface is positioned against the belt inner surface so that the belt outer surface contacts the finishing surface to define a finishing contact arc with respect to the backer bar radius. A tension, feed rate and pressure are applied to the finishing media. The backer bar radius is then adjusted so that the finishing contact arc covers the seam width. Using the finishing machine, the seam is then finished to remove the adhesive material. The backer bar radius is adjusted by any convenient means such as, for example, by grinding the backer bar. The finishing process results in a seam that is imageable.

### CROSS-REFERENCE TO RELATED APPLICATIONS

This is a divisional application of Ser. No. 09/723,150 filed Nov. 27, 2000, now pending.

### INCORPORATION BY REFERENCE OF ANOTHER U.S. PATENT

The applicant hereby incorporates by reference the disclosure of U.S. Pat. Number 5,612,773 to John S. Berkes et al., entitled “Intermediate transfer member,” granted Mar. 18, 1997, verbatim and with the same effect as though such disclosure were fully and completely set forth herein.

### FIELD OF THE INVENTION

This application relates generally to belts used in xerography, including intermediate transfer belts, and more particularly to a method of finishing a seam of a belt, including a method of finishing a seam of an intermediate transfer belt.

### BACKGROUND OF THE INVENTION

It is known to use seamed belts in xerography. For example, U.S. Pat. No. 5,549,999 to Eugene A. Swain et al., entitled “Process for coating belt seams,” in FIG. 1, col. 3, lines 66-67 and col. 4, lines 1-7 discloses a photoreceptor belt 10 including a seam 12.

Further, U.S. Pat. No. 5,997,974 to Edward L. Schlueter, Jr. et al., entitled “Invisible seam electrostatographic belt,” in FIG. 1 and col. 6, lines 29-40 discloses an endless belt 10 including a seam 11. Further, this Schlueter, Jr. et al. '974 patent in col. 12, lines 3-18 discloses using a conductive adhesive 48 in forming the belt seam.

Also, U.S. Pat. No. 6,068,722 to Robert C. U. Yu et al., entitled “Seam stress release in flexible electrostatographic imaging belts,” in FIG. 2 discloses a multiple-layered seamed flexible electrophotographic imaging belt 10 comprising a seam 30 formed with ultrasonic seaming welding. Further, this Yu et al. patent in col. 9, lines 18-34 discloses other seaming methods, including gluing, taping, stapling, pressure and heat fusing to form a continuous belt.

It is also known to finish the seams of such belts. For example, U.S. Pat. No. 5,418,349 to Eugene A. Swain et al., entitled “Process for reducing thickness of a polymeric photoconductive coating on a photoreceptor with laser,” in FIGS. 6-7 and col. 6, lines 40-50 discloses a photoreceptor belt 22 with seam 24, with the seam 24 being finished by a laser beam 10 in order to remove excess seam material.

Further, U.S. Pat. No. 5,549,193 to Edward L. Schlueter, Jr. et al., entitled “Endless seamed belt,” in col. 4, lines 47-55 discloses finishing a seam of a photoreceptor belt by means of air, ultrasonics or brushing. Further, this Schlueter, Jr. et al. '193 patent in col. 5, lines 39-51 discloses forming a photoreceptor belt seam by means of conventional adhesives, and then finishing the seam by means of buffing or sanding.

It is also known to use intermediate transfer belts in xerography. For example, U.S. Pat. No. 5,612,773 to John S. Berkes et al., entitled “Intermediate transfer member,” in FIG. 1 discloses using an intermediate transfer belt 28 in an electrophotographic printing machine.

However, there are problems associated with using a seamed belt for an intermediate transfer belt application. One problem is whether the latent image can be satisfactorily applied to the seamed portion of the belt or, in other words, whether the seam itself is “imageable.” This problem of belt seam imaging is noted in the foregoing John S. Berkes et al. patent wherein it is disclosed in col. 5, lines 32-42 that “the use of a seamless belt construction is important in that a seamed belt would require synchronization to prevent the seam from interfering with the image.”

Despite the foregoing problem with seam imaging, it is known to use a seamed belt as an intermediate transfer belt. In order to achieve a seamed intermediate transfer belt, however, the belt seam must be finished to make it imageable. As a result, currently such a belt seam is hand-sanded and polished in order to achieve a seam finish which will render the seam imageable, and thereby allow the belt to be used as an intermediate transfer belt. Such manual hand-finishing techniques have inherent limitations, of course, including quality control, throughput, efficiency and cost.

Finishing machines are known. For example, it is known to use such machines to achieve mechanized high-quality finishing of fuser rollers which are then used in xerographic printing machines. To date, however, it is not known to use a finishing machine to achieve a finished belt seam that is sufficiently imageable to allow the seamed belt to be used as an intermediate transfer belt.

The problem, thus, is how to use a finishing machine to finish the seam of a seamed intermediate transfer belt to thus achieve a finished seam that is imageable.

### SUMMARY OF THE INVENTION

In one aspect of the invention, a method is provided for finishing a seam of a belt. The belt comprises a belt outer surface and a belt inner surface. The seam comprises a seam outer surface of a seam width with adhesive material disposed thereon. The method includes a finishing machine comprising a finishing media with a finishing surface. The method further comprises a backer bar. The backer bar comprises a backer bar surface with a backer surface curvature based on a backer bar radius. The method comprises the steps of (a) position the backer bar surface against the belt inner surface so that the belt outer surface contacts the finishing surface to define a finishing contact arc with respect to the backer bar radius; (b) apply a tension, a feed rate and a pressure to the finishing media; (c) adjust the backer bar radius so that the finishing contact arc covers the seam width; and (d) using the finishing machine, finish the seam to remove the adhesive material.

In another aspect of the invention, an intermediate transfer belt is provided, the intermediate transfer belt comprising a seam that is finished in accordance with a finishing method. The intermediate transfer belt comprises a belt outer surface and a belt inner surface. The seam comprises a seam outer surface of a seam width with adhesive material disposed thereon. The finishing method includes a finishing machine comprising a finishing media with a finishing surface. The finishing method further comprises a backer bar. The backer bar comprises a backer bar surface with a backer surface curvature based on a backer bar radius. The finishing method comprises the steps of (a) position the backer bar surface against the belt inner surface so that the belt outer surface contacts the finishing surface to define a finishing contact arc with respect to the backer bar radius; (b) apply a tension, a feed rate and a pressure to the finishing media; (c) adjust the backer bar radius so that the finishing contact arc covers the seam width; and (d) using the finishing machine, finish the seam to remove the adhesive material.

In still another aspect of the invention, a printing machine is provided, the printing machine comprising an intermediate transfer belt. The intermediate transfer belt comprises a seam that is finished in accordance with a finishing method. The intermediate transfer belt comprises a belt outer surface and a belt inner surface. The seam comprises a seam outer surface of a seam width with adhesive material disposed thereon. The finishing method includes a finishing machine comprising a finishing media with a finishing surface. The finishing method further comprises a backer bar. The backer bar comprises a backer bar surface with a backer surface curvature based on a backer bar radius. The finishing method comprises the steps of (a) position the backer bar surface against the belt inner surface so that the belt outer surface contacts the finishing surface to define a finishing contact arc with respect to the backer bar radius; (b) apply a tension, a feed rate and a pressure to the finishing media; (c) adjust the backer bar radius so that the finishing contact arc covers the seam width; and (d) using the finishing machine, finish the seam to remove the adhesive material.

### BRIEF DESCRIPTION OF THE DRAWINGS

FIG. 1 depicts apparatus 100 suitable for demonstrating a method of finishing a belt seam, in accordance with the present invention.

FIG. 2 is a block diagram depicting a finishing machine 200 which comprises several components 30-34 of the apparatus 100.

FIG. 3 is a flow diagram 300 depicting a first embodiment of a method of finishing a belt seam, in accordance with the present invention.

FIG. 4 is a block diagram depicting an intermediate transfer belt 400 that has been finished in accordance with the method of FIG. 3.

FIG. 5 is a block diagram depicting a printing machine 500, which printing machine comprises the intermediate transfer belt 400 of FIG. 4.

### DESCRIPTION OF THE PREFERRED EMBODIMENTS

Briefly, in accordance with the present invention, an intermediate transfer belt includes a seam that is finished using a finishing machine. The intermediate transfer belt comprises a belt outer surface and a belt inner surface. The seam comprises a seam outer surface of a seam width with adhesive material disposed thereon. The finishing process includes a finishing media with a finishing surface and a backer bar. The backer bar comprises a backer bar radius and a backer bar surface with a backer surface curvature based on the backer bar radius. The backer bar surface is positioned against the belt inner surface so that the belt outer surface contacts the finishing surface to define a finishing contact arc with respect to the backer bar radius. A tension, feed rate and pressure are applied to the finishing media. The backer bar radius is then adjusted so that the finishing contact arc covers the seam width. Using the finishing machine, the seam is then finished to remove the adhesive material. The backer bar radius is adjusted by any convenient means such as, for example, by grinding the backer bar. The finishing process results in a seam that is imageable.

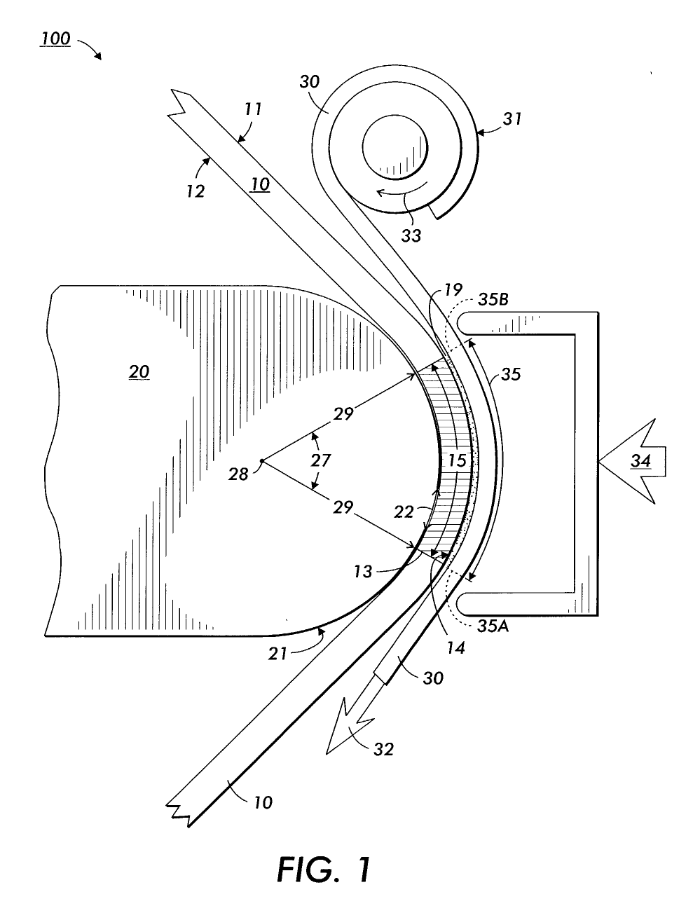

Referring now to FIG. 1, there is shown apparatus 100 suitable for demonstrating a method of finishing a belt seam, in accordance with the present invention. There is shown a belt 10, the belt 10 comprising a belt outer surface 11 and a belt inner surface 12. As shown the belt 10 includes a seam 13, the seam 13 comprising a seam outer surface 14 of a seam width 15 with adhesive material 19 disposed thereon.

Still referring to FIG. 1, there is shown a backer bar 20 with a backer bar surface 21. As shown, the backer bar 21 comprises a backer bar center 28 and a backer bar surface 21. Also as shown, the backer bar surface 21 is characterized by a backer surface curvature 22 based on a backer bar radius 29.

Still referring to FIG. 1, there is also shown a finishing media 30 with a finishing surface 31.

In one embodiment, the finishing media 30 comprises paper type 3M261X Imperial Lapping film.

In another embodiment, the finishing media 30 comprises paper type 3M262L Imperial Microfinishing paper.

The foregoing two (2) paper types are available from a variety of sources such as, for example, Abrasive Tool Corporation, 1555 Emerson Street, Rochester, N.Y. 14606, phone 716-254-4500.

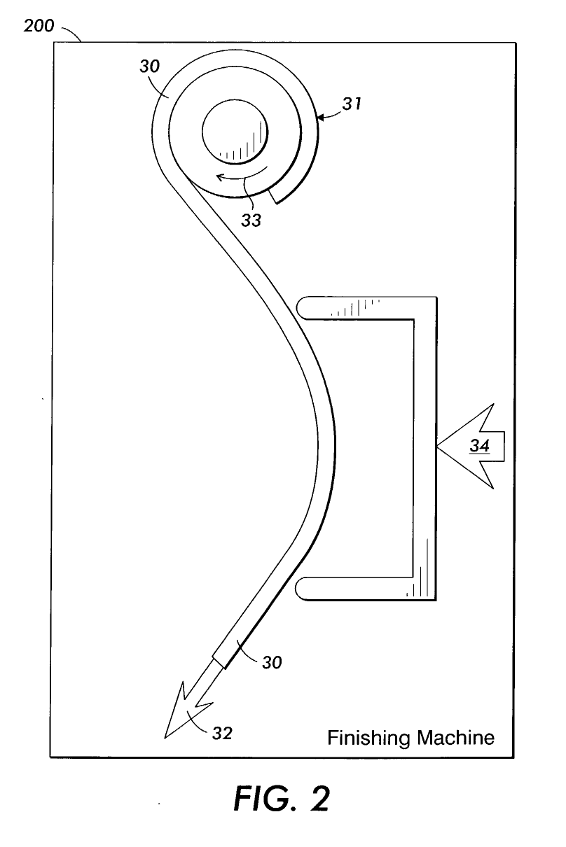

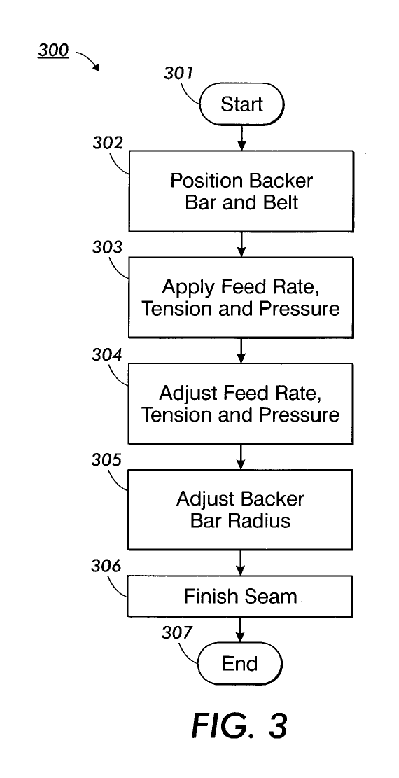

Referring now to FIG. 2, there is shown a finishing machine 200. With momentary reference to FIG. 1, it will be understood that the finishing machine 200 comprises the finishing media 30 discussed in FIG. 1 above, together with remaining elements designated 32, 33 and 34 which will be discussed in FIG. 3 below.

Still referring to FIG. 2, in one embodiment, for example, the finishing machine 200 comprises a “Superfinisher” product obtained from Grinding Equipment and Machinery Company, 15 Worthington Street, Youngstown, Ohio 44502, equipped with a 16-inch superfinishing head.

Referring now to FIG. 3, there is shown a flow diagram 300 depicting a first embodiment of a method of finishing the belt seam 13, in accordance with the present invention. As shown, the flow diagram 300 comprises seven (7) steps designated consecutively 301 through 307.

FIG. 3 is now discussed in the context of elements which are shown in FIG. 1. Hence, the following discussion can only be understood with simultaneous cross-reference to both FIG. 1 and FIG. 3.

After starting, step 301, the process goes to step 302.

In step 302, the backer bar surface 21 is positioned against the belt inner surface 12 so that the belt outer surface 11 contacts the finishing surface 31 to define a finishing contact arc 35 with respect to the backer bar radius 29 and backer bar center 28.

For good understanding, as shown in FIG. 1, the finishing contact arc 35 is defined by a first arc end 35A and a second arc end 35B. Thus defined, it will be understood that the finishing surface 31 and the belt outer surface 11 contact each other in the regions of the finishing surface 31 and the belt outer surface 11 that exist BETWEEN the first arc end 35A and the second arc end 35B. It will be further understood that the finishing arc 35 is based on several factors, such factors including, but not limited to, the backer bar radius 29 and the backer bar center 28.

The process then goes to step 303.

In step 303, a tension 32, a feed rate 33 and a pressure 34 are applied to the finishing media 30. In one embodiment, for example, the feed rate and pressure are initially set to achieve removal of the adhesive material 19. Also in this embodiment, the tension is initially set to achieve the desired seam coverage. The process then goes to step 304.

In step 304, the tension, pressure and feed rate are adjusted as required. In one embodiment, for example, the pressure is adjusted to achieve the desired surface finish. The process then goes to step 305.

In step 305, the backer bar radius 29 is adjusted so that the finishing contact arc 35 covers the seam width 15.

In one embodiment, the backer bar radius 29 is adjusted by grinding the backer bar 20.

In one embodiment, for example, the backer bar radius adjusting step 305 results in a finishing contact arc 35 that overlaps the seam width 15 by no more than 10%.

Returning to FIG. 3, upon completing step 305, the process goes to step 306.

In step 306, the finishing machine 200 finishes the seam 13 in the finishing contact arc 35 to remove the adhesive material 19. With cross-reference to FIG. 1, the pressure 34 urges the finishing surface 31 towards the belt outer surface 11 as the finishing machine 200 moves the finishing surface 31 orthogonal to the seam 13 at the feed rate 31 while oscillating the finishing surface 31 parallel to the seam 13. As a result of this finishing process step 306, the adhesive material 19 is removed from the seam outer surface 14.

Upon satisfactorily completing step 306, the process ends, step 307.

In one embodiment, the belt 10 comprises an intermediate transfer belt that may be used in a xerographic printing machine.

In another embodiment, the seam finishing step 306 results in a finished seam 13 that is imageable.

The following example is provided for good understanding.

In step 302, an initial backer bar 20 is selected, the initial backer bar 20 having an initial backer bar radius 29 equal to 50 mm. The backer bar 20 and belt 10 are positioned so that the belt inner surface 12 contacts the backer bar surface 21 in a backer contact arc 25 and the belt outer surface 11 contacts the finishing surface 31 in a finishing contact arc 35.

In step 303, the feed rate 33 initially is set to 20 centimeter per minute, the pressure 34 initially is set to 19 pounds per square inch and the tension 32 initially is set to 90 pounds.

In step 304, the pressure 34 is re-adjusted to 22 pounds per square inch and the tension 32 is re-adjusted to 80 pounds.

In step 305, the backer bar radius 29 is adjusted in order to optimize the finishing contact arc 35. The adjusting process is described below.

First, the seam width 15 is measured at 4.55 mm.

Second, it is desired to have the finishing contact arc 35 overlap the seam width 15 by about 10%. As a result, the desired finishing contact arc 35 is computed as 4.55 mm times 110% equals 5.005 mm, which is rounded to 5.0 mm.

Third, based on the present initial backer bar 20 with an initial bar radius 29 of 50 mm, the present finishing contact arc 35 is measured at 4.6 mm.

Fourth, calculate the angle 27 from the initial backer bar center 28 as 4.6 mm divided by 50 mm equals 0.0920 radians.

Fifth, calculate the desired adjusted radius 29 as 5.0 mm (desired finishing contact arc 35) divided by 0.0920 radians equals 54.3478 mm, which is rounded to 55 mm.

Sixth, the initial backer bar 20 is discarded and a new backer bar 20 is fabricated (by grinding) to achieve the desired backer bar radius 29 of 55 mm.

In summary, in step 305, the backer bar radius 29 is adjusted to a value of 55 mm in order to optimize the finishing contact arc 35 to a value of 5.0 mm.

In step 306, using the new backer bar 20 with the adjusted backer bar radius 29 of 55 mm, the seam 13 is finished for a time period of about 5 minutes.

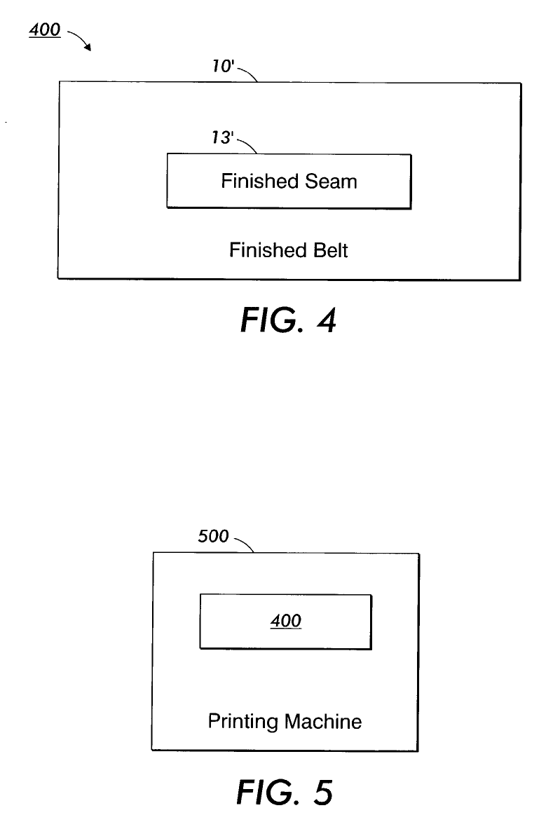

Referring now to FIG. 4, there is a block diagram 400 depicting an intermediate transfer belt 10′. As shown, the intermediate transfer belt 10′ comprises a seam 13′ which has been finished in accordance with a method of finishing a belt seam, in accordance with the present invention. It will be understood that the seam 13′ has been finished by the finishing process 300 depicted in FIG. 3. Still referring to FIG. 4, in one embodiment, the finishing process 300 results in the finished seam 13′ being imageable.

Referring now to FIG. 5, there is a block diagram depicting a printing machine 500, which printing machine comprises the finished intermediate transfer belt 400 depicted in FIG. 4.

In summary, there has been disclosed a method 300 of finishing a seam 13 of a belt 10, the belt 10 comprising a belt outer surface 11 and a belt inner surface 12, the seam 13 comprising a seam outer surface 14 of a seam width 15 with adhesive material 19 disposed thereon, the method 300 including a finishing machine 200 comprising a finishing media 30 with a finishing surface 31, the method 300 further comprising a backer bar 20, the backer bar 20 comprising a backer bar surface 21 with a backer surface curvature 22 based on a backer bar radius 29, the method 300 comprising the steps of:

(a) position 302 the backer bar surface 21 against the belt inner surface 12 so that the belt outer surface 11 contacts the finishing surface 31 to define a finishing contact arc 35 with respect to the backer bar radius 29;

(b) apply 303 a tension 32, a feed rate 33 and a pressure 34 to the finishing media 30;

(c) adjust 305 the backer bar radius 29 so that the finishing contact arc 35 covers the seam width 15; and

(d) using the finishing machine 200, finish 306 the seam 13 to remove the adhesive material 19.

In further summary, there has further been disclosed an intermediate transfer belt 10 (after finishing, this element 10 is depicted as element 10′ or element 400 in FIG. 4), comprising a seam 13 (after finishing, this element 13 is depicted as element 13′ in FIG. 4) that is finished in accordance with the above finishing method 300.

In continued summary, there has also been disclosed a printing machine 500 depicted in FIG. 5 comprising an intermediate transfer belt 400 (or element 10′) depicted in FIG. 4, the intermediate transfer belt comprising a seam (element 13′ in FIG. 4) that is finished in accordance with the above finishing method 300.

While various embodiments of a method of finishing a belt seam, an intermediate transfer belt finished in accordance with the same method, and a printing machine with an intermediate transfer belt finished in accordance with the same method, in accordance with the present invention, have been described hereinabove, the scope of the invention is defined by the following claims.

What is claimed is:

1. A method of finishing a seam of a belt, the belt comprising a belt outer surface and a belt inner surface, the seam comprising a seam outer surface of a seam width with adhesive material disposed thereon, the method including a finishing machine comprising a finishing media with a finishing surface, the method further comprising a backer bar, the backer bar comprising a backer bar surface with a backer surface curvature based on a backer bar radius, the method comprising the steps of:
(a) position the backer bar surface against the belt inner surface so that the belt outer surface contacts the finishing surface to define a finishing contact arc with respect to the backer bar radius;
(b) apply a tension, a feed rate and a pressure to the finishing media;
(c) adjust the backer bar radius so that the finishing contact arc covers the seam width; and
(d) using the finishing machine, finish the seam to remove the adhesive material.

2. The method of claim 1, including a step of adjusting the tension, pressure and feed rate.

3. The method of claim 1, the backer bar radius adjusting step (c) resulting in a finishing contact arc that overlaps the seam width by no more than 10%.

4. The method of claim 1, the backer bar radius adjusting step including a step of grinding the backer bar.

5. The method of claim 1, where the finishing media comprises paper type 3M261X Imperial Lapping film.

6. The method of claim 1, where the finishing media comprises paper type 3M262L Imperial Microfinishing paper.

7. The method of claim 1, where the finishing machine comprises a “Superfinisher” product obtained from Grinding Equipment and Machinery Company, Youngstown, Ohio.

8. The method of claim 1, where the belt comprises an intermediate transfer belt.

9. The method of claim 8, the seam finishing step (d) resulting in a finished seam that is imageable.

10. An intermediate transfer belt comprising a seam that is finished in accordance with a finishing method, the intermediate transfer belt comprising a belt outer surface and a belt inner surface, the seam comprising a seam outer surface of a seam width with adhesive material disposed thereon, the finishing method including a finishing machine comprising a finishing media with a finishing surface, the finishing method further comprising a backer bar, the backer bar comprising a backer bar surface with a backer surface curvature based on a backer bar radius, the finishing method comprising the steps of:
(a) position the backer bar surface against the belt inner surface so that the belt outer surface contacts the finishing surface to define a finishing contact arc with respect to the backer bar radius;
(b) apply a tension, a feed rate and a pressure to the finishing media;
(c) adjust the backer bar radius so that the finishing contact arc covers the seam width; and
(d) using the finishing machine, finish the seam to remove the adhesive material.

11. The intermediate transfer belt of claim 10, the finishing method including a step of adjusting the tension, pressure and feed rate.

12. The intermediate transfer belt of claim 10, the backer bar radius adjusting step (c) resulting in a finishing contact arc that overlaps the seam width by no more than 10%.

13. The intermediate transfer belt of claim 10, the backer bar radius adjusting step including a step of grinding the backer bar.

14. The intermediate transfer belt of claim 10, where the finishing media comprises paper type 3M261X Imperial Lapping film.

15. The intermediate transfer belt of claim 10, where the finishing media comprises paper type 3M262L Imperial Microfinishing paper.

16. The intermediate transfer belt of claim 10, where the finishing machine comprises a “Superfinisher” product obtained from Grinding Equipment and Machinery Company, Youngstown, Ohio.

17. The intermediate transfer belt of claim 10, the seam finishing step (d) resulting in a finished seam that is imageable.

18. A printing machine comprising an intermediate transfer belt, the intermediate transfer belt comprising a seam that is finished in accordance with a finishing method, the intermediate transfer belt comprising a belt outer surface and a belt inner surface, the seam comprising a seam outer surface of a seam width with adhesive material disposed thereon, the finishing method including a finishing machine comprising a finishing media with a finishing surface, the finishing method further comprising a backer bar, the backer bar comprising a backer bar surface with a backer surface curvature based on a backer bar radius, the finishing method comprising the steps of:
(a) position the backer bar surface against the belt inner surface so that the belt outer surface contacts the finishing surface to define a finishing contact arc with respect to the backer bar radius;
(b) apply a tension, a feed rate and a pressure to the finishing media;
(c) adjust the backer bar radius so that the finishing contact arc covers the seam width; and
(d) using the finishing machine, finish the seam to remove the adhesive material.

19. The printing machine of claim 18, the finishing method including a step of adjusting the tension, pressure and feed rate.

20. The printing machine of claim 18, the backer bar radius adjusting step (c) resulting in a finishing contact arc that overlaps the seam width by no more than 10%.

21. The printing machine of claim 18, the backer bar radius adjusting step including a step of grinding the backer bar.

22. The printing machine of claim 18, where the finishing media comprises paper type 3M261X Imperial Lapping film.

23. The printing machine of claim 18, where the finishing media comprises paper type 3M262L Imperial Microfinishing paper.

24. The printing machine of claim 18, where the finishing machine comprises a “Superfinisher” product obtained from Grinding Equipment and Machinery Company, Youngstown, Ohio.

25. The printing machine of claim 18, the seam finishing step (d) resulting in a finished seam that is imageable.
